(19) United States
(12) Patent Application Publication
(10) Pub. No.: US 2003/0152208 A1
(43) Pub. Date: Aug. 14, 2003

(54) Telecommunication screening system

(76) Inventor: Leslie A. Warren, Camarillo, CA (US)

Correspondence Address: Kaardal & Associates, PC, Attn: Ivar M. Kaardal, Suite 250, 3500 South First Ave. Circle, Sioux Falls, SD, 57105-5802, US

(21) Appl. No.: 10/071,656

(22) Filed: Feb. 8, 2002

(51) Int. Cl. H04M 3/42

(52) U.S. Cl. 379/210.02; 379/211.02

(57) ABSTRACT

A telecommunication screening system for screening phone calls prior to initiating an incoming call signal and for tracking the number of screened calls. The telecommunication screening system includes a device connectable to a phone line between an outlet and a telephone. The device would answer an incoming call and play a message identifying calls that are unwelcome then offer to pass the call through to the phone upon entry of a requested number by the caller. Upon input of the requested number, a signal will be sent through to the phone to ring the phone and connect the caller upon a user answering the phone.

### BACKGROUND OF THE INVENTION

1. Field of the Invention

The present invention relates to phone call screening devices and more particularly pertains to a new telecommunication screening system for screening phone calls prior to initiating an incoming call signal and for tracking the number of screened calls.

2. Description of the Prior Art

The use of phone call screening devices is known in the prior art. U.S. Pat. No. 5,604,792 describes an interactive telephone system for connecting a caller to a subscriber while providing anonymity unless identifying information is voluntarily revealed. Another type of phone call screening devices is U.S. Pat. No. 5,604,791 having an identifying system to provide a unique ring for calls from recognized or pre-identified calling numbers. U.S. Pat. No. 4,791,664 provides another system for identifying subscribers or otherwise previously identified and approved callers. Both U.S. Pat. No. 4,446,334 and U.S. Pat. No. 4,074,078 disclose methods or systems for permitting the completion of a phone call only by pre-approved callers. U.S. Pat. No. Des. 374,235 shows an ornamental appearance for a caller identification module.

While these devices fulfill their respective, particular objectives and requirements, the need remains for a device that is attachable to an existing phone system to screen calls from callers who have not been previously identified.

### SUMMARY OF THE INVENTION

The present invention meets the needs presented above by providing a message to callers that identifies call types, such as solicitation calls, that are not welcome.

Still yet another object of the present invention is to provide a new telecommunication screening system that tracks the number of calls that are not completed because the caller terminated the phone call in response to the message on the device.

Even still another object of the present invention is to provide a new telecommunication screening system that is attachable to an existing phone system.

To this end, the present invention generally comprises a device connectable to a phone line between an outlet and a telephone. The device would answer an incoming call and play a message identifying calls that are unwelcome then offer to pass the call through to the phone upon entry of a requested number by the caller. Upon input of the requested number, a signal will be sent through to the phone to ring the phone and connect the caller upon a user answering the phone.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The objects of the invention, along with the various features of novelty which characterize the invention, are pointed out with particularity in the claims annexed to and forming a part of this disclosure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front view of a new telecommunication screening system according to the present invention.

FIG. 2 is a schematic view of the processing of an incoming call by the present invention.

### DESCRIPTION OF THE PREFERRED EMBODIMENT

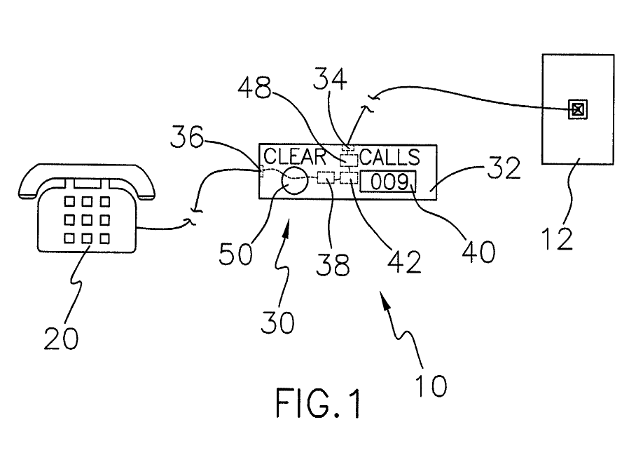

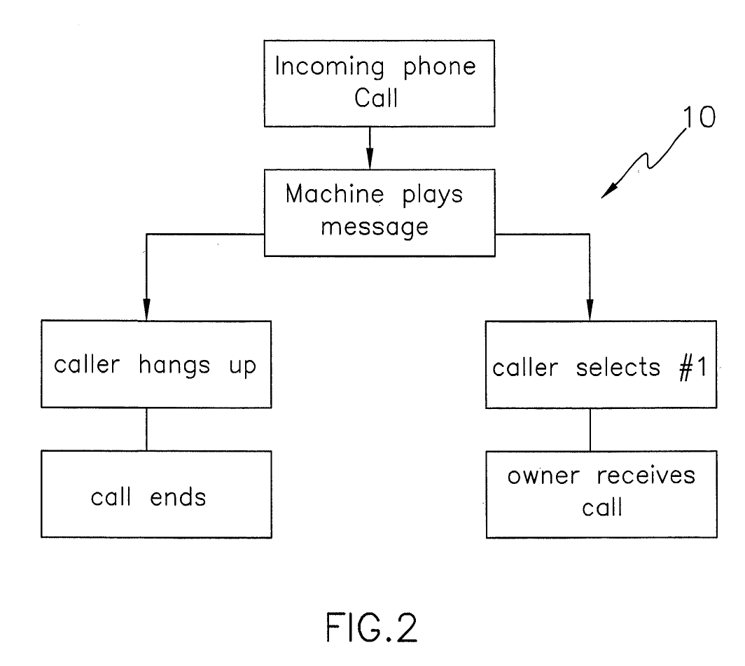

With reference now to the drawings, and in particular to FIGS. 1 and 2 thereof, a new telecommunication screening system embodying the principles and concepts of the present invention and generally designated by the reference numeral 10 will be described.

As best illustrated in FIGS. 1 and 2, the telecommunication screening system 10 generally comprises a telecommunication outlet 12 for transmitting incoming calls, a phoneset 20 operationally coupled to the telecommunication outlet 12, and a screening device 30 operationally coupled between the telecommunication outlet 12 and the phoneset 20 for receiving the incoming calls. The screening device 30 plays a pre-recorded message to a caller setting forth standards for identifying an undesired type of incoming call, such as a solicitation call, prior to forwarding a received incoming call to the phoneset 20.

The screening device 30 transmits the incoming call to the phoneset 20 only upon the caller pressing a pre-determined number on their phone, such as a single digit identified in the pre-recorded message.

The screening device generally comprises a housing 32 having an inlet port 34 and an outlet port 36. A message playback device 38 is coupled to and positioned in the housing 32. A display screen 40 is also coupled to the housing 32. A microcontroller 42 is positioned in the housing 32 and operationally coupled to the message playback device 38. The microcontroller 42 is operationally coupled to the display screen 40 to display a number of calls received by the screening device 30 in which a caller discontinues the incoming call prior to the screening device 30 transmitting the incoming call to the phoneset 20. Calls sent through to the phoneset 20 will initiate ringing of the phoneset 20 as in a typical incoming call. Optionally, the screening device 30 may incorporate an incoming message recorder 48 to record a message from calls transmitted to the phoneset 20 but not answered within a pre-determined time period or number of rings of said phoneset 20.

A display clearing button 50 is also coupled to the housing 32. The display clearing button 50 is operationally coupled to the microcontroller 42 such that the microcontroller 42 clears the display screen 40 upon depression of the display clearing button 50.

In use, the screening device is coupled to a phone outlet to intercept incoming calls and play a pre-recorded message to discourage unwelcome calls from reaching a phoneset coupled to the screening device. Welcome caller would be requested to press a button on their own phone to transmit the call to the phoneset of the person being called. The display screen would track the number of calls received by the screening device but discontinued without being transmitted on to the phoneset, thus providing an indication of the number of unwelcome calls effectively screened.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A telecommunications call screening system comprising:
a telecommunication outlet for transmitting incoming calls;
a phoneset operationally coupled to the telecommunication outlet;
a screening device operationally coupled between the telecommunication outlet and the phoneset for receiving the incoming calls, the screening device playing a pre-recorded message to a caller setting forth standards for identifying an undesired type of incoming call prior to forwarding a received incoming call to the phoneset.

2. The telecommunication call screening system of claim 1, further comprising:
the screening device transmitting the incoming call to the phoneset upon the caller pressing a pre-determined number.

3. The telecommunication call screening system of claim 1 wherein the screening device comprises:
a housing having an inlet port and an outlet port;
a message playback device coupled to the housing;
a display screen coupled to the housing;
a microcontroller operationally coupled to the message playback device, the microcontroller being operationally coupled to the display screen to display a number of calls received by the screening device in which a caller discontinues the incoming call prior to the screening device transmitting the incoming call to the phoneset.

4. The telecommunication call screening device of claim 3, further comprising:
a display clearing button coupled to the housing, the display clearing button being operationally coupled to the microcontroller such that the microcontroller clears the display screen upon depression of the display clearing button.

5. A telecommunications call screening system comprising:
a telecommunication outlet for transmitting incoming calls;
a phoneset operationally coupled to the telecommunication outlet;
a screening device operationally coupled between the telecommunication outlet and the phoneset for receiving the incoming calls, the screening device playing a pre-recorded message to a caller setting forth standards for identifying an undesired type of incoming call prior to forwarding a received incoming call to the phoneset;
the screening device transmitting the incoming call to the phoneset upon the caller pressing a pre-determined number; and
wherein the screening device comprises:
a housing having an inlet port and an outlet port,
a message playback device coupled to the housing,
a display screen coupled to the housing,
a microcontroller operationally coupled to the message playback device, the microcontroller being operationally coupled to the display screen to display a number of calls received by the screening device in which a caller discontinues the incoming call prior to the screening device transmitting the incoming call to the phoneset, and
a display clearing button coupled to the housing, the display clearing button being operationally coupled to the microcontroller such that the microcontroller clears the display screen upon depression of the display clearing button.
